(19) United States
(12) Patent Application Publication
(10) Pub. No.: US 2023/0240306 A1
(43) Pub. Date: Aug. 3, 2023

(54) System for Preparing and/or Heating a Food Product

(71) Applicant: i-clean Technologies GmbH, Hockenheim (DE)

(72) Inventors: Rüdiger Töpfer, Bobenheim am Berg (DE); Alois Klingel, Bruhl (DE); Peter Koolen, Bergen op Zoom (NL); Achilles Aichmalotidis, Heidelberg (GR)

(21) Appl. No.: 17/667,846

(22) Filed: Feb. 9, 2022

(30) Foreign Application Priority Data
Feb. 3, 2022 (EP) 22154981.9

(51) Int. Cl. A21B 3/16; A21B 1/00

(52) U.S. Cl. CPC A21B 3/16; A21B 1/00

(57) ABSTRACT

The present invention is related to a system for preparing and heating a food product within a cavity (8), said system comprising a self-cleaning device with a spraying device (10) for spraying a cleaning fluid into the cavity (8), in which a detergent holder (24) is placed. The detergent holder (24) is arranged on a framework or an accessing door (18) of the cavity (8), a multi-component cartridge (32) being received in the detergent holder (24), the detergent holder (24) being held in an inclined position at an angle (60) towards a center of the cavity (8), the multi-component cartridge (32) being sprayed on by spray jets (58) emerging from the spraying device (10) in a continuous or discontinuous manner.

### FIELD OF THE INVENTION

The present invention is related to a system for preparing and/or heating a food product in a cavity, said system comprising a self-cleaning device with a spraying device for spraying a cleaning fluid into the cavity, and a detergent holder. Further, the present invention is related to a method for cleaning a cavity of a system for preparing and/or heating a food product.

### BACKGROUND OF THE INVENTION

WO 2006/037 354 A1 is related to a method for dosing a solid detergent, detergent dispenser and use of a method and dispenser. The invention discloses a method for dosing a pre-determined quantity of a solid detergent from a solid detergent reservoir by dissolving some of the solid detergent in the reservoir in a rinsing liquid to form a detergent solution, comprising the following steps: a) Continuously or discontinuously feeding detergent solution generated at the detergent reservoir into a dissolving tank, b) measuring the amount of rinsing liquid supplied to form the detergent solution that is fed to the dissolving tank as well as any amount of rinsing liquid directly supplied to the dissolving tank, c) measuring the detergent concentration of the detergent solution in the dissolving tank, d) calculating the quantity of detergent in the detergent solution in the dissolving tank by multiplication of the results of the measurements in steps b) and c), e) feeding the amount of detergent solution representing the required quantity of detergent from the dissolving tank to a utilization point, preferably to equipment or system to be cleaned and/or disinfected. Further, this document relates to a corresponding detergent dispenser and preferred use of both.

US 2021/0095860 A1 is related to a validation of addition of cleaning chemistry to a self-cleaning oven. According to this disclosure, a system for controlling the initiation of a cleaning process is provided. The cleaning process is directed to an interior of an appliance and includes a detection sensor and a processor communicating with the detection sensor. The detection sensor may be configured to generate detection sensor data based on a sensed condition in a field of detection of the detection sensor, which may comprise one or more predetermined locations. The processor may control the initiation of an appliance cleaning process. The appliance cleaning process may comprise receiving detection sensor data representative of a first time and a second time, generating an initial condition based on the received detection sensor data representative of the first time, and generating a new condition based on the received detection sensor data representative of the second time. The processor may be additionally configured to compare the initial condition and the new condition and determine if cleaning product is present.

EP 3 507 547 B1 discloses a system comprising a self-cleaning rotisserie oven and a method for cleaning a self-cleaning rotisserie oven. A system is disclosed comprising a self-cleaning rotisserie oven, the self-cleaning rotisserie oven comprising a casing, an oven cavity with the casing for a food product, such as poultry, a heater for heating the food product and a self-cleaning device, the self-cleaning device comprising a spraying device for spraying a cleaning fluid in the oven cavity and a first outlet in a lower part of the oven cavity for discharging cleaning fluid. The system further comprises a cleaning fluid supply for supplying cleaning fluid to the spraying device and a discharge in communication with the oven cavity, for disposing of waste fluid, the self-cleaning rotisserie oven comprising a first detergent holder at a first height level and a second level and a second detergent holder at a second height level, the second detergent holder being provided at a higher level than the first detergent holder. The self-cleaning rotisserie oven comprises a control for controlling at least the self-cleaning device wherein the control is configured to perform the following steps: Filling the oven cavity with a first amount of cleaning fluid to at least the first height level and below the second height level, cleaning the oven cavity with the first amount of cleaning fluid and a first portion of detergent from the first detergent holder, discharging the first amount of cleaning fluid and the first portion of detergent from the oven cavity, filling the oven cavity with a second amount of cleaning fluid to at least a second height level, cleaning the oven cavity with the second amount of cleaning fluid and a second portion of detergent from the second detergent holder and discharging the second amount of cleaning fluid and the second portion of detergent from the oven cavity.

### DISCLOSURE OF THE INVENTION

An object of the present invention is to facilitate cleaning processes, which are necessary from time to time to clean cavities of food preparing or food heating systems such as an oven or a rotisserie oven. According to the present invention a system is provided for preparing and/or heating a food product within a cavity, said system comprising a self-cleaning device with a spraying device for spraying a cleaning fluid into the cavity and a detergent holder, wherein the detergent holder is arranged on a framework or an accessing door of the cavity, a multi-component cartridge is received in the detergent holder, the detergent holder is maintained at an inclined angle towards a center of the cavity and the multi-component cartridge is being sprayed on by spray jets emerging from the spraying device in a continuous or discontinuous manner.

The system according to the present invention allows for a cleaning of a cavity with at least two cleaning steps depending on the number of different detergent compositions stored within the multi-component cartridge.

Advantageously, the system according to the present invention comprises the detergent holder, which is removably mounted on the framework or accessing door of the cavity, the detergent holder being made of a bent wire. Since the bent wire offers a very simply way of manufacturing the detergent holder, a variety of detergent holders can be manufactured easily. The bent wire further provides excellent heat conducting properties.

Further, the system according to the present invention comprises the detergent holder made of a bent wire, which defines a circular space with an opening for receiving the multi-component cartridge. This allows for a very simple mounting of the multi-component cartridge by clipping it into the circular space of the detergent holder and likewise removing it easily when the multi-component cartridge is exhausted, i. e. when it is emptied.

Furthermore, the system according to the present invention comprises the detergent holder having a zigzag line portion for hinging it into notches of a framework or an accessing door of the cavity. This allows an easing mounting and removal of the detergent-holder when not in use.

In a very advantageous manner, the system according to the present invention comprises the detergent-holder that keeps the multi-component cartridge in use in an inclined position directed towards the center of the cavity, the inclination angle being in the range of 7° to 13°.

The multi-component cartridge comprises a first chamber with a first volume for a first cleaning composition and at least one further, second chamber with a second volume for a second cleaning composition. The multi-component cartridge in this configuration allows for at least two different cleaning steps. If however a multi-component cartridge is used with more than two chambers, further cleaning steps can be performed within a cleaning cycle.

In the system according to the present invention, the first and second chambers of the multi-component cartridge each are sealed by a respective seal, which is used as initial seal.

The upper seal sealing the first chamber is substantially made of polyethylene glycol (PEG) and/or alkyl polyglycosides (APG) and/or mixtures of glycose, inducing a softening of the upper seal at a temperature between 47° C. and 49° C. and a melting of the upper seal at a temperature between 48° C. and 52° C. and/or completely dissolving the upper seal within less than 20 minutes.

Thus, by the material composition of the upper seal the temperature of opening, i. e. initiating a first cleaning cycle can be determined. Further, as long as said upper seal is in use, i. e. while the first chamber is emptied, the second chamber remains closed.

A further advantageous aspect of the system of the present invention is that the second seal seals the second chamber, the second seal being made of a hardened material, which is insoluble at a temperature below 50° C. Thus, the second chamber and its content remains sealed as long as the first cleaning cycle is performed with the first cleaning composition contained in the first chamber, the seal of which has been opened.

Further, the second seal comprises a mixture of linear unbranched fatty acids, fatty acid amines, fatty acid esters, long-chain primary and polyhydric alcohols or carboxylic acids. For enhancement of thermal and mechanical stability, the second seal comprises cellulose fibers in an amount of 1% to 3%.

According to the system of the present invention, the second seal is made such that when sprayed on by a cleaning fluid directly or indirectly, having a temperature of about 60° C. +/−2° C., a melting process of the material of the second seal is initiated. Thus a retarded release of the second cleaning composition contained in the second chamber is performed when the melting process of the second seal has started.

A further advantageous aspect of the present invention is that the system is configured in such a way that upon contact of the second cleaning composition with the spraying jets after melting of the second seal an exothermic reaction is initiated resulting in an emptying of the second chamber at an enhanced temperature level between 80° C. and 90° C.

According to the present invention, the multi-component cartridge of the system comprises at least a first cleaning composition and a second cleaning composition which are incompatible with respect to one another.

A further advantageous aspect of the present invention is that the multi-component cartridge comprises tapered portions next to the first and second chamber, respectively, to allow for a gravimetric emptying thereof after the seals have been removed.

The method of the present invention for cleaning a cavity of a system for preparing and/or heating a food product comprises the following steps:
a) a multi-component cartridge is arranged in an inclined position in a detergent holder within a cavity,
b) the multi-component cartridge comprises at least two chambers, each being sealed by separate seals, respectively, the materials of which melt at different temperatures,
c) the upper seal of the first chamber melts when being sprayed on by spraying jets having a temperature T1 between 45° C. and 49° C., thus releasing a first cleaning composition into the cavity,
d) during step c) the seal of the second chamber remains sealed,
e) after step c), the cavity is rinsed by a rinsing fluid,
f) after heating the rinsing fluid contained in the cavity to a temperature T2 of about 60° C., exceeding temperature T1, the second cleaning composition is released in the cavity delayed in time with respect to the first cleaning composition according to step c).

Furthermore, according to this method an exothermic reaction of the second cleaning composition after removal of the lower seal is initiated by an increasing temperature within the cavity, thereby bringing about a better cleaning performance and a better and faster release of the second cleaning composition, because the seal of the second chamber is melting faster and thus the chamber is opening faster. The accomplished faster release of the second cleaning composition leads to a better cleaning performance, since the length of the second cleaning cycle is extended.

A first aspect of the present method is that the second chamber of the multi-component cartridge is continuously rinsed by the spray jets so that the entire volume of the second cleaning composition of the second chamber is used for cleaning purposes.

### ADVANTAGES OF THE PRESENT INVENTION

The present invention discloses a very simple detergent holder, which receives a multi-component cartridge. Depending on the number of cleaning steps to be performed the multi-component cartridge may comprise at least two chambers, each chamber containing a volume of a detergent, i. e. either a first cleaning composition or a second cleaning composition or even other cleaning compositions as for example enzymes or other materials with different properties.

The detergent holder can be very easily mounted on the framework or the accessing door of the cavity. In contrast to the solutions according to the prior art only one detergent holder can be used which is easily removable from the cavity during operation, i. e. while heating or preparing food.

According to the present invention a single cartridge is used having at least two different chambers, each of the chambers holding a different cleaning composition. In this way, one cartridge is used for implementing at least two cleaning cycles within a system for preparing and heating a food product. Still further, a time-delayed release of a second cleaning composition is achieved by means of the material composition of the second seal of the second chamber of the multi-component cartridge.

Another advantage of the present invention lies in the fact that in a multi-component cartridge two different cleaning compositions can be used, one of them initializing an exothermic reaction once the second seal of the second chamber containing the second cleaning composition is opened. The exothermic reaction increases the temperature to about 80° C. to 90° C., whereby energy is saved, which otherwise would be necessary to heat the rinsing fluid to a temperature above the temperature T2 of the second cleaning cycle.

According to the present invention, the inclined position of the multi-component cartridge allows for a time-delayed emptying of each of the chambers of the multi-component cartridge storing non-compatible cleaning compositions. The first and second cleaning composition can be released independently and time-delayed during the first and second cleaning cycle, respectively.

In the present invention, the first cleaning composition advantageously allows for a pre-cleaning in order to degrade organic compounds, e. g. grease and oily substances, by a biochemical process, e. g. enzymatically, so that the fluid of the first cleaning cycle has a low viscosity and may hence be pumped or sprayed. Thus, even in case of a highly polluted cavity the fluid to be used, which preferably is water, has a relatively low volume and is highly energy-efficient.

Still further, by using the spray jets for the entire cleaning of the chambers of the multi-component cartridge it is avoided that residues of the cleaning compositions remain in the chambers, the chambers being continuously or discontinuously rinsed with water.

According to the present invention a substantially complete emptying of the cartridge is achieved. It is advantageous that the chemical components of the cleaning compositions are completely released so that the cartridge can be disposed with the household garbage, i. e. no particular handling due to hazardous substances is necessary. Often cartridges containing residues of cleaning compositions are disposed of illegally with the household garbage. Such cartridges containing residues of chemical substances can contaminate the soil, thus contributing to environmental pollution. Because the cartridge of the present invention is fully emptied by way of multiple rinsing, it does not constitute hazardous material and can be disposed of with the household garbage.

### BRIEF DESCRIPTION OF THE DRAWINGS

The present invention is further described by the accompanying drawings, in which:

FIG. 1 shows a system for preparing and heating a food product within a cavity and a spray device thereof,

FIG. 2 shows a detergent holder,

FIG. 3 shows the detergent holder being arranged on a framework or accessing door of a cavity,

FIG. 4 shows a multi-component cartridge arranged in the detergent holder according to FIG. 3 arranged in an inclined position on the framework,

FIG. 5 shows a side view of the detergent holder arranged on a framework or an accessing door of the cavity in an inclined position, the multi-component cartridge being directed towards the center of the cavity to be cleaned and

FIG. 6 shows the detergent holder holding a multi-component cartridge being sprayed on by the spray jets.

### EMBODIMENTS OF THE INVENTION

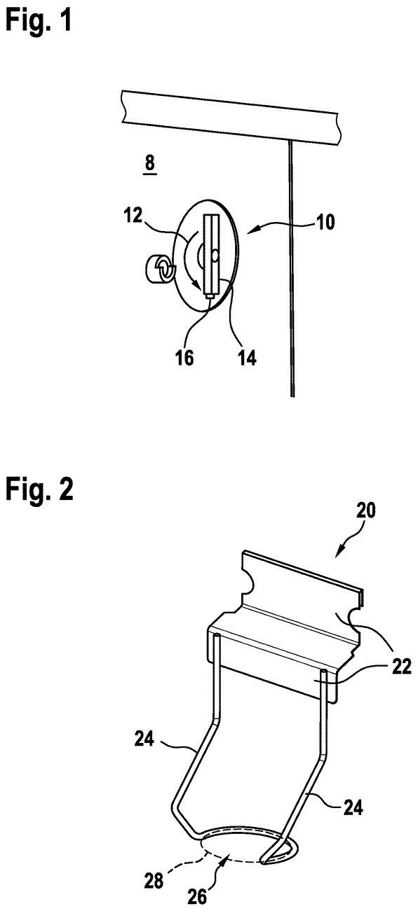

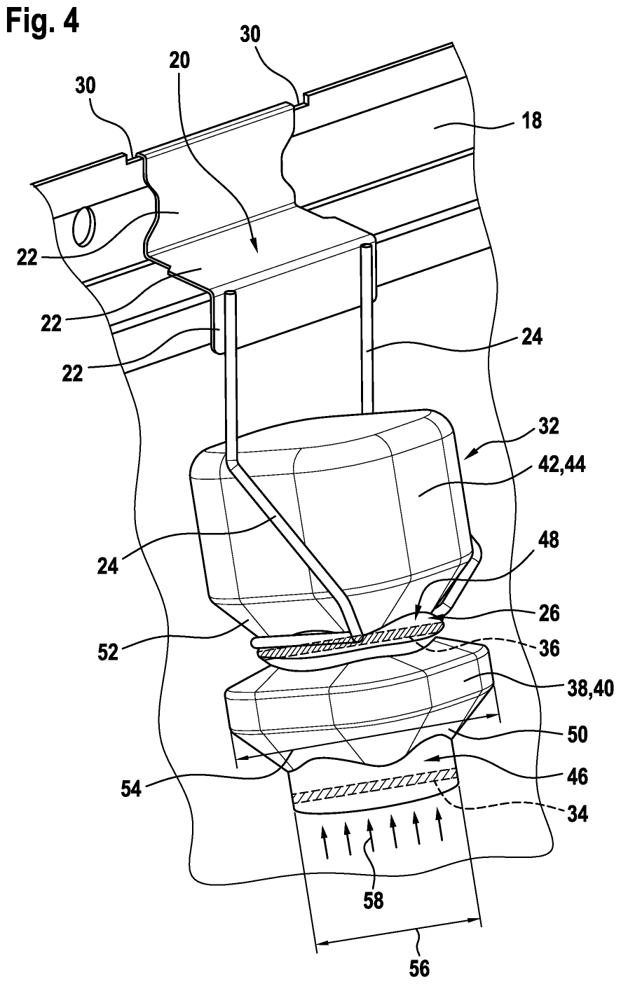

According to FIG. 1, the cavity 8 of a system for preparing a food product is schematically illustrated. In one of the limiting walls of the cavity 8 a spraying device 10 is arranged. The spraying device 10 comprises for example a spraying bar 14 rotating in a rotational direction 12 around an axis. The spraying bar 14 comprises at least one spraying nozzle 16, from which spray jets 58 emerge as schematically illustrated in FIG. 4.

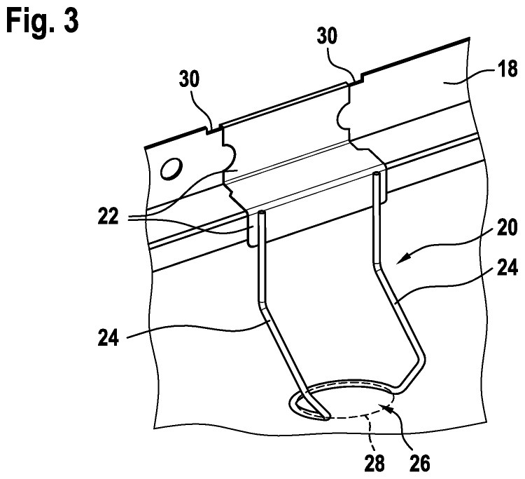

FIG. 2 shows a cartridge-receiving unit 20, i. e. a detergent holder 24. The cartridge-receiving unit 20 comprises a portion having a zigzag line 22, the detergent holder 24 being made of a metallic material, particularly a bent wire. Said bent wire of the detergent holder 24 comprises a circular space 28, which is accessible by means of an opening 26. Upon arrangement of the detergent holder 24 on a framework or an accessing door 18 limiting the cavity 8, a multi-component cartridge 32 may be inserted in a lateral direction into the opening 26 of the circular space 28 as shown in FIG. 3.

In FIG. 3 it is shown that the detergent holder 24 made of a bent wire is mounted in notches 30 arranged of the framework or accessing door 18 of the cavity 8 of the system for heating or preparing a food product according to the present invention. As shown in FIG. 3 the detergent holder 24 is hinged in the notches 30 by its upper end part. Thus, the detergent holder 24 can very easily be removed or mounted on the framework or accessing door 18. Once the zigzag line portion 22 of the detergent holder 24 is removably mounted, the later operating position of a multi-component cartridge 32 according to FIG. 4 is predetermined. The inclination angle 60, i. e. the operating angle of the mounted multi-component cartridge 32 is defined by way of the bent wire of the detergent holder 24. In case the cleaning device of the cavity 8 is not used, the detergent holder 24, i. e. the cartridge-receiving unit 20 can be easily removed from the cavity 8 so that normal food preparing processes can be performed. Once a cleaning operation with different cleaning cycles is necessary, the cartridge-receiving unit 20 can be easily mounted as shown in FIG. 3.

The perspective view according to FIG. 4 shows the multi-component cartridge 32 engaged in the cartridge-receiving unit 20, i. e. the detergent holder 24.

In FIG. 4 the multi-component cartridge 32 comprises a first chamber 38 at its lower end, said first chamber 38 defining a first volume 40 for a first cleaning composition 46. Further, the multi-component cartridge 32 comprises a second chamber 42 having a second volume 44 holding a second cleaning composition 48. The first cleaning composition 46 and the second cleaning composition 48 are incompatible with respect to one another. According to the present invention, a first chamber 38 is sealed by an upper seal 34, whereas the second chamber 42 is sealed by a lower seal 36. Thus, both cleaning compositions 46 and 48 are initially separated from one another.

Still further, both chambers 38, 42 each comprise a tapered portion, i. e. the first tapered portion 50 of the first chamber 38 and the second tapered portion 52 of the second chamber 42. At the bottom of the tapered portions 50, 52, respectively, the chambers 38, 42 are sealed by the seals 34, 36, respectively.

The first and second tapered portions 50, 52 each have a second diameter 56, which is smaller than a first diameter 54 of the chambers 38, 42, respectively.

As schematically disclosed in FIG. 4, the upper seal 34 of the multi-component cartridge 32 is sprayed on by spray jets 58.

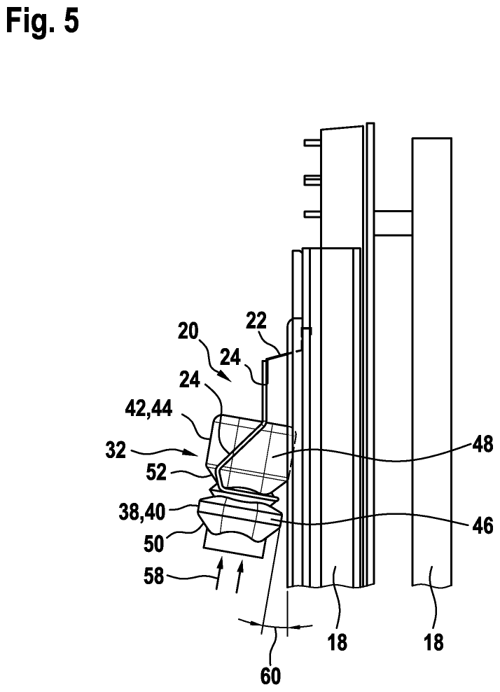

An angle 60 defining the inclined position of the multi-component cartridge arranged in the detergent holder 24 is best shown in the side view according to FIG. 5.

According to the present invention the bent wire of the detergent holder 24 is made of thin metal material which allows for a favorable heat transfer of the cleaning fluid to the multi-component cartridge 32. This accelerates the reaching of a melting temperature T1, T2 of the seals 34, 36 sealing the first chamber 38 and the second chamber 42, respectively.

The lower seal 36 sealing the second chamber 42 of the multi-component cartridge 32 is made in such a way that the lower seal 36 during the first cleaning cycle with a temperature T1 of the cleaning fluid between 47° C. and 49° C. maintains its sealing position so that the second cleaning composition 48 of the second chamber 42 is protected against the entry of fluid during the first cleaning cycle so as to prevent a too early entry of the second cleaning composition 48 into the cavity 8.

As soon as the first cleaning cycle has ended, used cleaning fluid is drained from the cavity 8 and the cavity 8 is rinsed. After rinsing, the cavity 8 is closed again and filled for a second time with a defined volume of water. Subsequently, the fluid contained in the cavity 8 is heated from temperature T1 used in the first cleaning cycle up to a temperature T2, which is necessary for the second cleaning cycle amounting to about 60° C. +/−2° C. After the temperature T2 has been reached, the lower seal 36 begins to melt so that the second cleaning composition 48 of the second chamber 42 enters the cavity 8 and the fluid volume contained therein. Once the lower seal 36 has opened an exothermic reaction of the second cleaning composition 48 is initialized so that a complete emptying of the second chamber 42 can be realized. During the emptying of the second chamber 42 the interior of the second chamber 42 is continuously sprayed with water in order to remove substantially all of the residues of the second cleaning composition 48 of the multi-component cartridge 32. Due to the shape of the detergent holder 24 for receiving the multi-component cartridge 32 a positioning of the multi-component cartridge 32 is realized at an angle of 7° to 13° pointing toward the center of the cavity 8 to be cleaned. Thus it is accomplished that the cleaning compositions 46, 48, e. g. the first and second volumes 40, 44, respectively, contained in the chambers 38, 42, are released time-delayed so that both cleaning compositions 46, 48 are separated from each other and do not enter the cavity 8 at the same time. A further feature of the present invention is that the cleaning compositions 46, 48 stored in the chambers 38, 42 of the multi-component cartridge 32 are two incompatible mixtures with different cleaning properties during the cleaning cycle.

The first cleaning composition 46 stored within the first volume 40 of the first chamber 38 is used for pre-cleaning of about 60% to 99% of the dirt and has the primary object to remove fatty and oily pollutions by means of a biochemical process so that the cleaning fluid used during the first cleaning cycle, maintains a low viscosity, thus being sprayable. Thereby, despite a high amount of dirt, the fluid volume, preferably water, is relatively low, which in turn saves energy.

In the multi-component cartridge 32 both chambers 38 and 42 are provided with a first tapered portion 50 and a second tapered portion 52, respectively. This is advantageous, because the cleaning compositions 46, 48 stored within the chambers 38, 42, respectively, are released gravimetrically. Residues of the cleaning compositions 46, 48 are removed from the chambers 38, 42 by continuous rinsing of the interior by the spray jets 58. Thus, at the end of the cleaning cycles performed at temperatures T1 and T2, respectively, the multi-component cartridge 32 is fully emptied so that no special waste treating becomes necessary.

Furthermore, it deserves mentioning that the materials of which the upper seal 34 and the lower seal 36 are made, differ from one another. Whereas the upper seal 34 is made of a temperature-sensitive and water-soluble material and substantially made of polyethylene glycols (PEG) and/or alkyl polyglycols (APG) and/or glycose mixtures which soften at a temperature between 47° C. and 48° C., melt between 48° C. and 52° C. and dissolve within less than 20 minutes, the lower seal 36 on the other hand has a different material composition. The lower seal 36 sealing the second chamber 42 during the first cleaning cycle makes sure that at a temperature T1 of less than 50° C. the second chamber 42 remains closed during the first cleaning cycle, thus preventing an early release of the second cleaning composition 48 out of the second chamber 42. The lower seal 36 is substantially made of a mixture of linear unbranched fatty acids, fatty acid amines, fatty acid esters, long-chain primary and polyhydric alcohols or carboxylic acids. For reasons of thermal and mechanical stabilizing of the lower seal 36 during the first cleaning cycle the composition of the material of the lower seal 36 comprises 1% to 3% of cellulose fiber material.

Still further, the lower seal 36 has melting properties such that it begins to melt during the second cycle as soon as it is directly or indirectly sprayed on with a cleaning fluid having a temperature of 60° C. +/−2° C. Upon contact of the lower seal 36 with the second cleaning composition 48 and the spray jets 58 an exothermic reaction is initialized which results in a temperature increase to from 80° C. to 90° C. so that the melting of the lower seal 36 is accelerated. Thus, the release of the second cleaning composition 48 is enhanced and has a duration of about less than 10 minutes. Small residues of the second cleaning composition 48 within the second chamber 42 will be rinsed out by means of continuously spraying on by operation of the spray jets 58 into the interior of the multi-component cartridge 32 until the second chamber 42 is completely empty.

As a further advantageous embodiment the multi-component cartridge 32 can be made as a foiled tab, the foil being water-soluble.

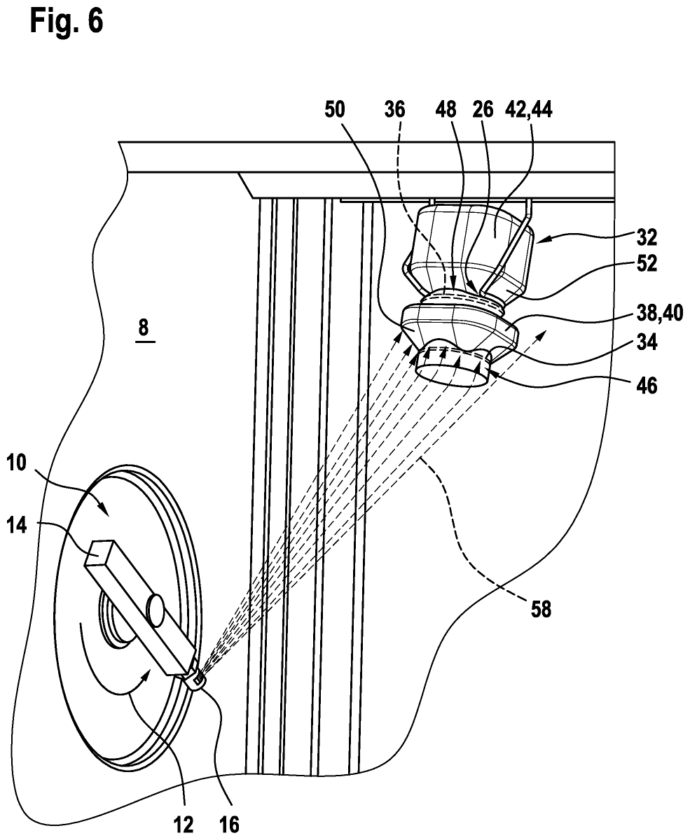

FIG. 6 shows a perspective view of the cavity 8 of the cleaning device. The cleaning device comprises a spraying device 10, which comprises a spraying bar 14 moving in rotational direction 12. At the bottom of the spraying bar 14 at least one spraying nozzle 16 is arranged emitting a number of spray jets 58. It can be derived from FIG. 6 that the spray jets 58 emerging from the spraying nozzle 16 are directed to the bottom of the multi-component cartridge 32, which is integrated into the cartridge-receiving unit 20, i. e. the detergent holder 24. The multi-component cartridge 32 comprises the first chamber 38 containing the first volume 40 of the first cleaning composition 46 and the second chamber 42 containing the second volume 44 comprising the second cleaning composition 48. The spray jets 58 first contact the upper seal 34 sealing the first chamber 38. Once the upper seal 34 has melted, the first cleaning composition 46 is being released into the cavity 8.

Upon further action of the spray jets 58 being heated up to a second temperature T2 exceeding the first temperature T1 used in the first cleaning cycle, the upper seal 34 is being melted so that the second cleaning composition 48 contained in the second volume 44 contained in the second chamber 42 is being released into the cavity 8 to perform the second cleaning cycle. The multi-component cartridge 32 as shown in FIG. 6 arranged in the detergent holder 24 further comprises the first and second tapered portions 50, 52 already described in connection with FIG. 4.

The invention is not limited to the embodiments described herein and the aspects highlighted. Rather, within the scope indicated by the claims, a multitude of variations is possible with respect to the skilled in the art.

### REFERENCE NUMERALS

### 8 Cavity

10 Spraying device
12 Rotational direction

### 14 Spraying bar

16 Spraying nozzle
18 Framework/accessing door
20 Cartridge-receiving unit
22 Zigzag line portion
24 Detergent holder

### 26 Opening

28 Circular space

### 30 Recess/notch

32 Multiple-component cartridge
34 Upper seal
36 Lower seal
38 First chamber
40 First volume
42 Second chamber
44 Second volume
46 First cleaning composition
48 Second cleaning composition
50 First tapered portion
52 Second tapered portion
54 First diameter portion
56 Second diameter portion
58 Spray jets
60 Inclination angle

1. System for preparing and heating a food product within a cavity, said system comprising a self-cleaning device with a spraying device for spraying a cleaning fluid into the cavity, and a detergent holder, wherein the detergent holder is arranged on a framework or an accessing door of the cavity, a multi-component cartridge being received in the detergent holder, the detergent holder being held in an inclined position at an angle towards a center of the cavity, the multi-component cartridge being sprayed on by spray jets emerging from the spraying device in a continuous or discontinuous manner.

2. System according to claim 1, wherein said detergent holder is removably mounted on said framework or accessing door of said cavity, said detergent holder being made of bent wire.

3. System according to claim 1, wherein said detergent holder made of a bent wire defines a circular space having an opening for receiving said multi-component cartridge.

4. System according to claims 1, wherein said detergent holder comprises a zigzag line shaped portion hinged in notches of said framework or accessing door of said cavity.

5. System according to claims 1, wherein said angle defining the inclined position of said multi-component cartridge towards the center of said cavity preferably is between 7° to 13°.

6. System according to claims 1, wherein said multi-component cartridge comprises a first chamber holding a first volume of a first cleaning composition and at least a second chamber holding a second volume of a second cleaning composition.

7. System according to claims 1, wherein each of said at least first and second chambers is secured by an initial seal, respectively.

8. System according to claims 1, wherein said upper seal sealing said first chamber is made substantially of polyethylene glycols (PEG) and/or alkyl polyglycosides (APG) and/or mixtures of glycose inducing a softening of said upper seal at between 47° C. and 50° C., and a melting of said upper seal at between 48° C. and 52° C. and/or a time of complete dissolution of said upper seal of less than 20 minutes.

9. System according to claims 1, wherein said lower seal sealing said second chamber is made of a hardened material being non-soluble at a temperature below 50° C.

10. System according to claim 9, wherein said lower seal comprises a mixture of linear unbranched fatty acids, fatty acid amines, fatty acid esters, long-chain primary and polyhydric alcohols or carboxylic acids.

11. System according to claim 9, wherein said lower seal for enhancement of thermal and mechanical stability comprises 1% to 3% cellulose fibers.

12. System according to claim 9, wherein said lower seal is made such that when sprayed on by a cleaning fluid directly or indirectly, having a temperature of about 60° C. +/−2° C., a melting process of said second seal is initiated.

13. System according to claims 1, wherein upon contact of said second cleaning composition with said spraying jets after melting of said lower seal an exothermic reaction is initiated resulting in an emptying of said second chamber.

14. System according to claims 1, wherein said multi-component cartridge comprises at least a first cleaning composition and a second cleaning composition, respectively, which are incompatible with respect to one another.

15. System according to claims 1, wherein said multi-component cartridge comprises tapered portions next to said first and second chamber, respectively, to allow for a gravimetric emptying thereof after said seals have been removed.

16. Method for cleaning a cavity of a system for preparing and/or heating a food product, wherein
a) a multi-component cartridge is arranged in an inclined position in a detergent holder within a cavity,
b) said multi-component cartridge comprising at least two chambers, each being sealed by separate seals, respectively, the materials of which melt at different temperatures,
c) the upper seal of the first chamber melts when being sprayed on by spraying jets and at a temperature T1 between 45° C. and 49° C., thus releasing a first cleaning composition into the cavity,
d) while said lower seal of said second chamber remains sealed,
e) after step c) the cavity is rinsed,
f)after heating the rinsing fluid contained in the cavity the rinsing fluid is heated to a temperature T2 of about 60° C., exceeding temperature T1, and said seconding cleaning composition is released into the cavity delayed in time with respect to said first cleaning composition according to method step c).

17. Method according to claim 16, wherein according to f) an exothermic reaction of said second cleaning composition after removal of said lower seal is initiated.

18. Method according to claim 16, wherein said second chamber of said multi-component cartridge is rinsed continuously by said spray jets.
